(19) United States
(12) Patent Application Publication
(10) Pub. No.: US 2003/0036931 A1
(43) Pub. Date: Feb. 20, 2003

(54) Device and method for chartering a seat on ground transportation

(76) Inventors: William R. Maulsby, Naperville, IL (US); Vipon Sandhir, Chicago, IL (US)

Correspondence Address: Christopher J. Gaspar, Milbank, Tweed, Hadley & McCloy LLP, 1 Chase Manhattan Plaza, New York, NY, 10005-1413, US

(21) Appl. No.: 09/932,388

(22) Filed: Aug. 17, 2001

(51) Int. Cl. G06F 17/60

(52) U.S. Cl. 705/5

(57) ABSTRACT

The present invention relates to a device and method for chartering an individual seat on a ground transportation vehicle for carriage to or from an event of interest.

### FIELD OF THE INVENTION

The present invention relates to ground transportation services and, more particularly, to a device and method for chartering ground transportation.

### BACKGROUND OF THE INVENTION

Each year, people from common geographic areas attend events together, but travel to them separately. For example, a number of sports fans attend professional and collegiate sporting events in locations outside their own communities. Similarly, music enthusiasts travel to distant venues to watch their favorite artists perform. Although many of these travelers are from the same geographic areas, few charter ground transportation to take them to their particular events of interest.

At present, information about certain events (e.g., professional sporting event schedules or artist touring dates) can be accessed using the Internet and, more particularly, World Wide Web sites. For example, the web sites of some professional sports teams and clubs specify the times and locations of upcoming games, and also direct an individual to a set of screens or another site altogether that allows that person to purchase a ticket to the game or sporting event of interest. Similarly, the Internet sites of several popular music artists provide tour dates and locations, as well as some type of “online” mechanism for buying a ticket to a show. Through use of conventional mechanisms, including sites on the Internet, individuals are now able both to obtain information about a particular event, and to purchase a ticket to that event in one online transaction. Access to information made possible by use of the Internet, coupled with online mechanisms for selecting and purchasing event tickets, has made event ticketing easier and less time consuming for certain individuals. However, one part of the event experience is missing transportation to the event.

For certain events, ground transportation (e.g., bus, motor coach, van, limousine or taxi cab) may be a practical, comfortable or affordable way for an individual to travel to the event. In some cases, ground transportation vehicles may also provide a flexible and economical way to move many people from place to place in one trip. Despite the advantages of ground transportation, however, some people do not know how to arrange ground transportation for carriage to an event they may wish to attend.

### SUMMARY OF THE INVENTION

In one aspect, the invention features a method including receiving, over a network, an indication that an identifier presented by another has been selected, providing data indicative of an arrangement for ground transportation associated with an event, and receiving data descriptive of an order for a seat on a ground transportation vehicle for carriage between a stop and the event.

In another aspect, the invention features a method including receiving, over an internet network, an indication that an icon displayed by another has been selected, presenting for display a first content page providing data descriptive of an event with a corresponding identifier indicative of an arrangement for ground transportation associated with the event, receiving a request for information about ground transportation services associated with the event, presenting for display a second content page providing data descriptive of a route for ground transportation associated with the event, receiving a request for information about the route, presenting for display a third content page requesting an order for a seat on a ground transportation vehicle for carriage between a stop and the event, receiving the order, presenting for display a fourth content page requesting payment information, receiving the payment information, and presenting for display a fifth content page providing data descriptive of a confirmation of the order and payment therefore.

In a further aspect, the invention features a method including receiving an indication that an identifier presented by another has been selected, providing data indicative of an arrangement for ground transportation associated with an event, and receiving data descriptive of an order for a seat on a ground transportation vehicle for carriage between a stop and said event.

In yet another aspect, the invention features a method including causing to be sent an indication that an identifier presented by another has been selected, receiving data indicative of an arrangement for ground transportation associated with an event, and providing data descriptive of an order for a seat on a ground transportation vehicle for carriage between a stop and the event.

In a further aspect, the invention features a method including receiving an indication that an identifier presented by another has been selected, providing data indicative of an arrangement for ground transportation associated with an event, and receiving data descriptive of a request for a seat on a ground transportation vehicle for carriage between a stop and the event.

In yet another aspect, the invention features a method including receiving, over an internet network, a request for purchase of a seat on a ground transportation vehicle for carriage between a stop and an event, and providing, over the internet network, confirmation of the request for purchase of the seat on a ground transportation vehicle.

In a further aspect, the invention features a method including requesting, over an internet network, purchase of a seat on a ground transportation vehicle for carriage between a stop and an event, and receiving, over the internet network, confirmation of the request for purchase of the seat on a ground transportation vehicle.

In yet another aspect, the invention features a device having means for receiving an indication that an identifier presented by another has been selected, means for providing data indicative of an arrangement for ground transportation associated with an event, and means for receiving data descriptive of an order for a seat on a ground transportation vehicle for carriage between a stop and the event.

In a further aspect, the invention features a device having means for receiving, over an internet network, an indication that an icon displayed by another has been selected, means for presenting for display a first content page providing data descriptive of an event with a corresponding identifier indicative of an arrangement for ground transportation associated with the event, means for receiving a request for information about ground transportation services associated with the event, means for presenting for display a second content page providing data descriptive of a route for ground transportation associated with the event, means for receiving a request for information about the route, means for presenting for display a third content page requesting an order for a seat on a ground transportation vehicle for carriage between a stop and the event, means for receiving the order, means for presenting for display a fourth content page requesting payment information, means for receiving the payment information, and means for presenting for display a fifth content page providing data descriptive of a confirmation of the order and payment therefore.

In yet another aspect, the invention features a device with a memory having embodied therein data descriptive of an arrangement for ground transportation associated with an event, and a processor in communication with the memory, the processor configured to receive, over a network, an indication that an identifier presented by another has been selected, to provide data indicative of an arrangement for ground transportation associated with an event, and to receive data descriptive of an order for a seat on a ground transportation vehicle for carriage between a stop and the event.

In a further aspect, the invention features a computer-readable storage medium encoded with processing instructions for implementing a method, the processing instructions for directing a computer to perform the steps of receiving an indication that an identifier presented by another has been selected, providing data indicative of an arrangement for ground transportation associated with an event, and receiving data descriptive of an order for a seat on a ground transportation vehicle for carriage between a stop and the event.

### BRIEF DESCRIPTION OF THE DRAWINGS

The foregoing features and other aspects of the invention are explained in the following description taken in conjunction with the accompanying drawings and the claims appended at the end of the description, wherein:

FIG. 1 is a block diagram of a system including a seat chartering device according to one embodiment of the invention.

FIG. 2 is a block diagram of a seat chartering device according to one embodiment of the invention.

FIG. 3 is a block diagram of a partner server shown in FIG. 1.

FIG. 4A is a block diagram of one type of user interface device shown in FIG. 1.

FIG. 4B is a block diagram of another type of user interface device shown in FIG. 1.

FIGS. 5A-5C show a flowchart illustrating one aspect of steps performed by one embodiment of a seat chartering device in chartering an individual seat on a ground transportation vehicle for carriage associated with an event.

FIG. 6A shows an exemplary portion of a sports team's content page that does not contain event specific information, as displayed by a user interface device of the type shown in FIG. 4A.

FIG. 6B shows an exemplary portion of a sports team's content page that contains event-specific information, as displayed by a user interface device of the type shown in FIG. 4A.

FIG. 7 shows an exemplary portion of a content page provided by one embodiment of a seat chartering device that contains event-specific information, as displayed by a user interface device of the type shown in FIG. 4A.

FIG. 8 shows an exemplary portion of a content page that shows routes for ground transportation, as displayed by a user interface device of the type shown in FIG. 4A.

FIG. 9 shows an exemplary portion of a content page for use in providing certain order information to a seat chartering device, as displayed by a user interface device of the type shown in FIG. 4A.

FIG. 10 shows an exemplary portion of a content page for use in providing additional passenger information to a seat chartering device, as displayed by a user interface device of the type shown in FIG. 4A.

FIG. 11 shows an exemplary portion of a content page for use in providing payment information to a seat chartering device, as displayed by a user interface device of the type shown in FIG. 4A.

FIG. 12 shows an exemplary portion of a content page confirming order information, as displayed by a user interface device of a type shown in FIG. 4A.

FIG. 13 shows an exemplary portion of a content page confirming purchase of an order, as displayed by a user interface device of the type shown in FIG. 4A.

FIGS. 14A-14C show a flowchart illustrating one aspect of steps performed by one using the seat chartering device shown in FIG. 1 in chartering an individual seat on a ground transportation vehicle for carriage associated with an event.

### DETAILED DESCRIPTION OF PREFERRED EMBODIMENTS

Various embodiments of the present invention will now be described in greater detail with reference to the drawings.

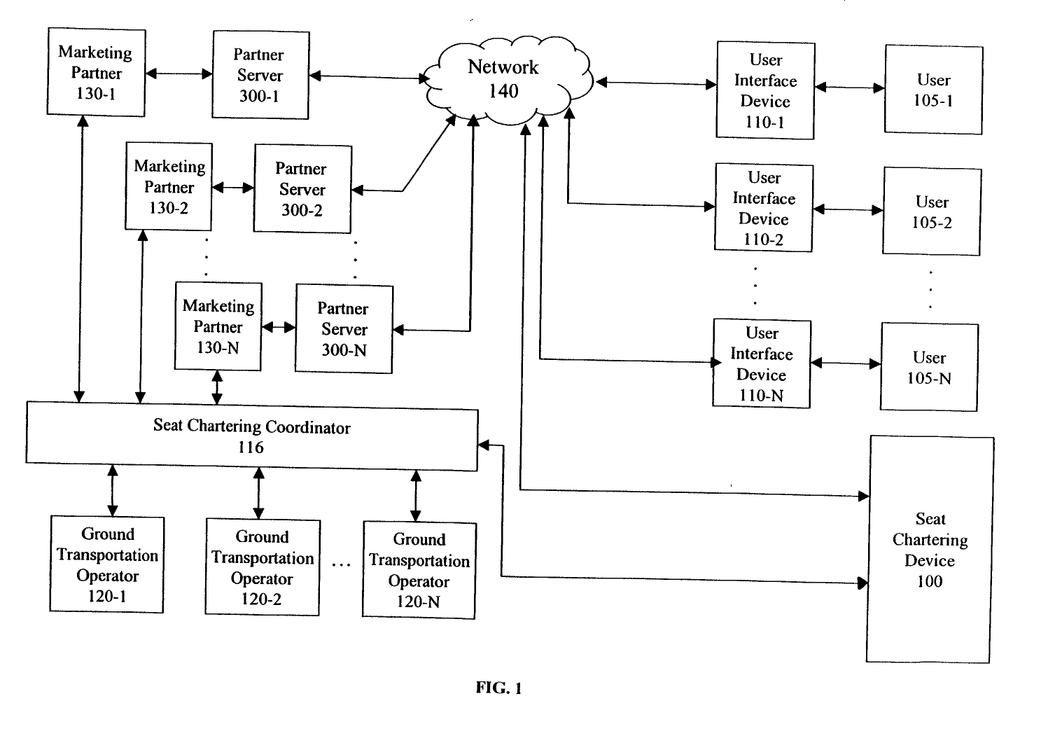

FIG. 1 shows the relationship of one embodiment of a seat chartering device 100 of the present invention to other devices of a broader system. As shown, one embodiment of the seat chartering device 100 is a part of and operates in connection with a system further including one or more user interface devices 110 (each operated by a user 105) and one or more partner servers 300 (each populated with information by a marketing partner 130), all in communication with each other via a network 140.

As shown in FIG. 1, one or more partner servers 300 and one or more user interface devices 110 may provide information to one embodiment of the seat chartering device 100 to allow a user 105 to be directed from one site containing information about an event to another site containing information about ground transportation associated with that event. The seat chartering device 100 of one embodiment may also enable a user 105 to transmit a request to purchase one or more seats for carriage on a ground transportation vehicle, and to receive a confirmation of travel arrangements, as is further described herein. The terms “charter,” “chartering,” and the like as used herein may include review, selection, reservation and/or purchase of ground transportation services, but are not limited to transactions requiring a purchase. The “users” 105 of an embodiment described herein may include individuals 105-1 interested in carriage to and/or from a particular event, as well as intermediaries such as travel agents 105-2, personal assistants 105-3, tour operators 105-4, and the like.

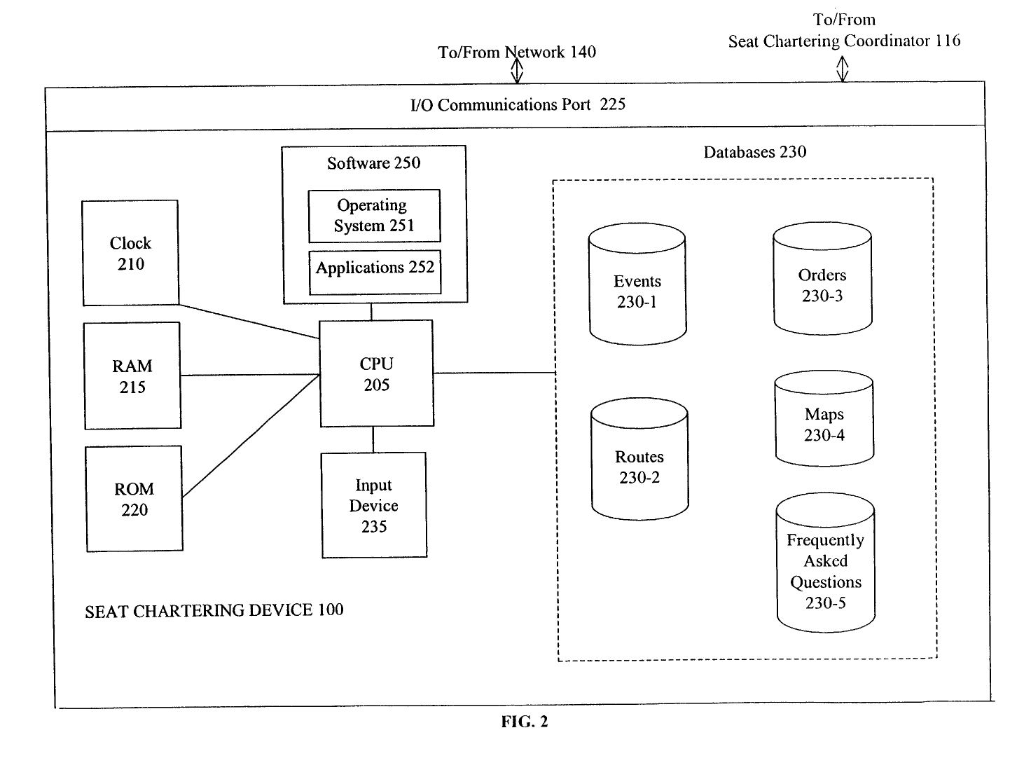

FIG. 2 is a block diagram showing the architecture of a seat chartering device 100 according to one embodiment of the present invention. As FIG. 2 illustrates, the seat chartering device 100 of one embodiment is a server system having a central processing unit (CPU) 205 that is linked to each of the following devices by a shared data bus or by dedicated connections: clock 210, random access memory (RAM) 215, read only memory (ROM) 220, one or more input/output (I/O) communications ports 225, a plurality of databases 230, and software 250. In a preferred embodiment, the RAM 215 is large enough to avoid problems such as slow page loading or other type of failure caused by an overload of simultaneous connections being attempted. Each I/O communications port 225 is configured to include multiple communications channels for simultaneous connections. The CPU 205 of one embodiment of the seat chartering device 100 is also in communication with one or more input devices 235 (e.g., a keypad or a scanner) which enable information and instructions to be input into the seat chartering device 100 for storage therein and use in operation. The software components 250 of such an embodiment include an operating system 251, applications 252, and databases 230, to store information and perform the operations or transactions described herein. The CPU 205 of one embodiment of the seat chartering device 100 performs processing functions in accordance with the operating system 251. In one embodiment, database management software applications 252 may also be implemented in the seat chartering device 100. Such a seat chartering device 100 may access data storage devices 215, 220, 230 which may contain graphics, text and executable files (e.g., file types such as .html, .exe, .txt.). Although one embodiment of the seat chartering device 100 is a single server, a plurality of additional servers (not shown) may also be included as part of the seat chartering device 100.

Although the network 140 used in connection with one embodiment of the seat chartering device 100 is an Internet, a wide area network (WAN), a local area network (LAN), an intranet or other network capable of communicating data between hardware and/or software devices may also be appropriate for certain applications. The Internet used in connection with one embodiment of the seat chartering device 100 is a global communications network that interconnects numerous computer devices and sub-networks to each other. The Internet may use an addressing scheme called Internet Protocol to uniquely identify every device (e.g., user interface devices 110, routers (not shown), and servers 100, 300) connected to it.

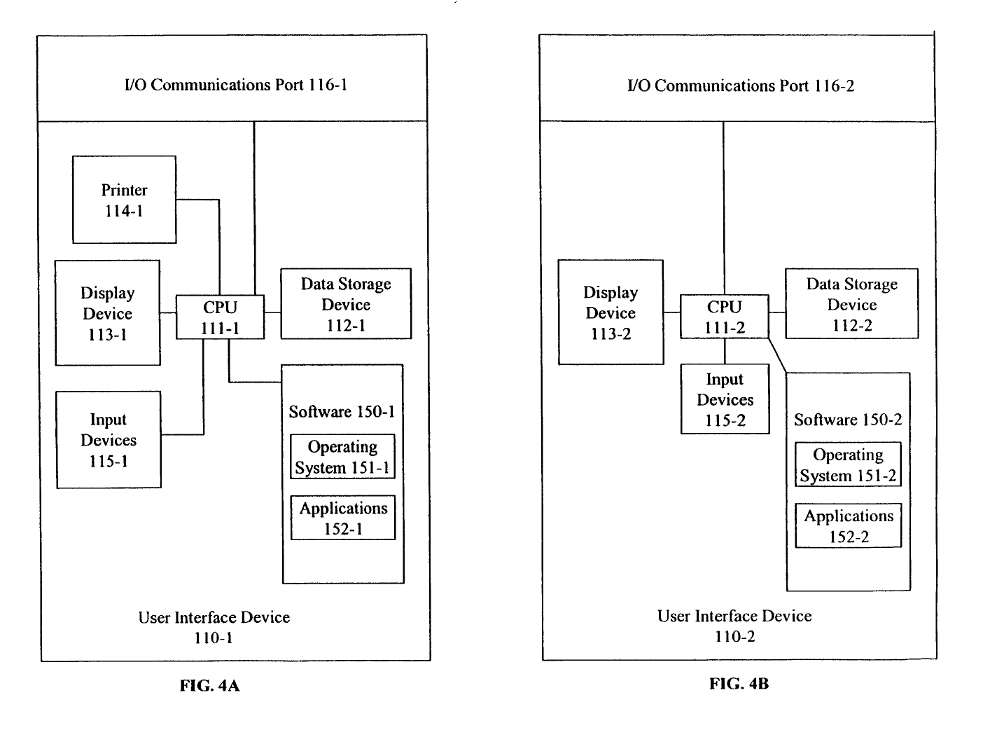

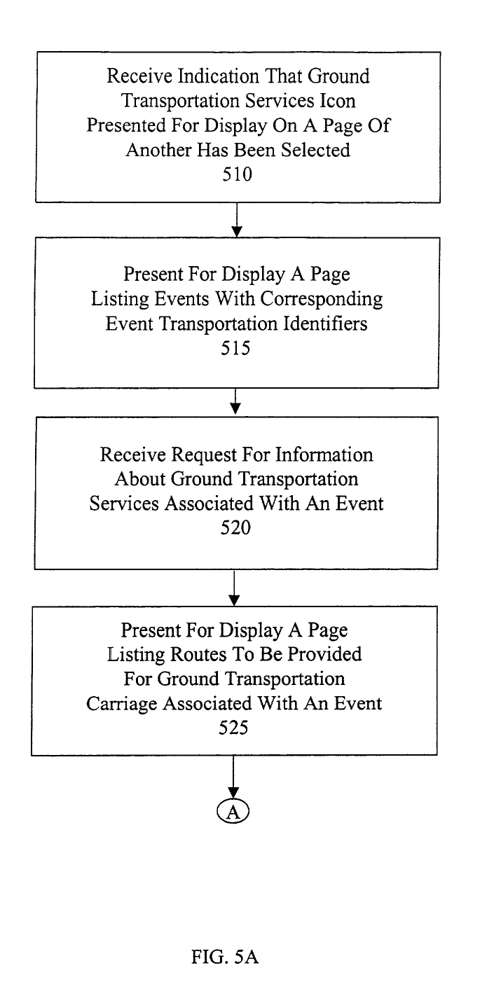

Much of such an Internet operates according to a “client/server” model. In one type of client/server model, a browser software application 152 runs on a user's 105 local “client” user interface device 110 (e.g., a personal computer as shown in FIG. 4A) while additional software 250, 350 runs on a remotely located “server” computer (e.g., a seat chartering device 100 according to one embodiment, or another server 300). Using such an internet, the browser application 152 running on the client computer 110 may request information from a server by sending a hypertext transfer protocol (HTTP) request. For example, a client computer 110 shown in FIG. 1 may request a particular content page from a server 300. When a browser 152 contacts the server 300, it asks the server 300 for content pages built with a corresponding programming language such as, e.g., hypertext mark up language (HTML). After processing the HTTP request, the server 300 sends the requested content page to the client device 110 in the form of an HTTP response. The browser 152 then interprets the information sent by the server 300 and displays it on the client computer 110. Through display of various content pages on a client computer 110, a user 105 is able to review and/or respond to content stored in and presented by a server 300. In this way, a user 105 may interface and interact with one or more servers 100, 300, including the seat chartering device 100 of one embodiment, to conduct the transactions they support. In addition, the seat chartering device 100 of one embodiment may communicate with user interface devices 110 by HTTP that is secured using secure protocol (e.g., secure socket layer).

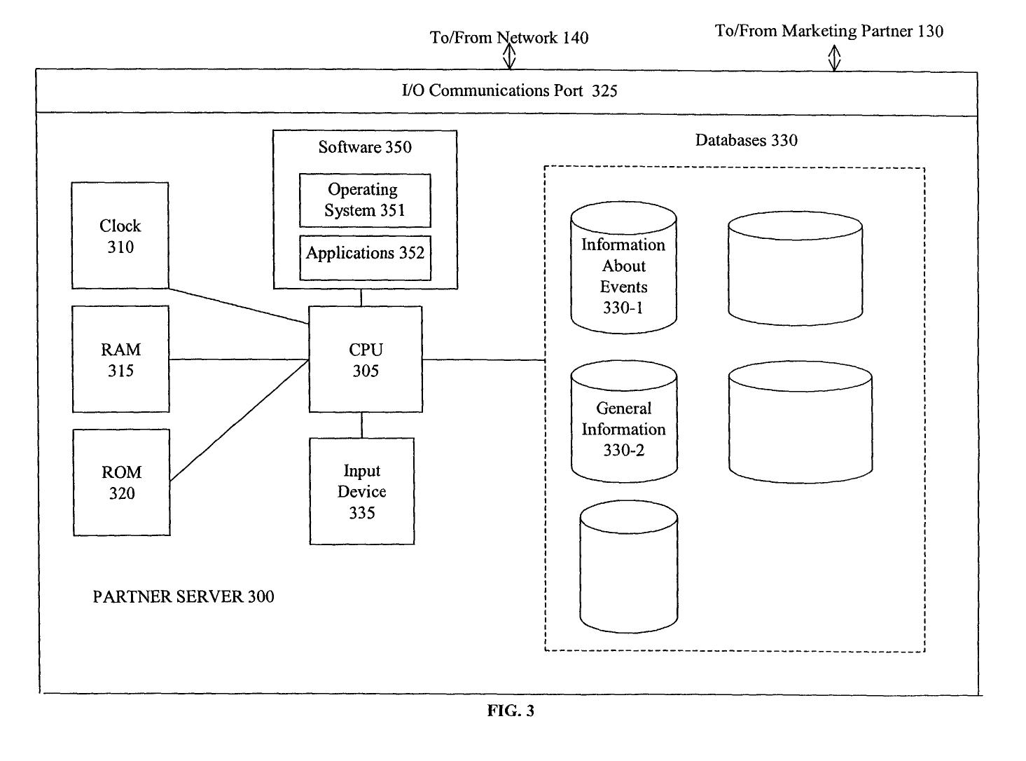

FIG. 3 is a block diagram showing the architecture of one type of partner server 300 that may be used by a marketing partner 130. As FIG. 3 illustrates, a partner server 300 may have a CPU 305 linked to each of the following elements by a shared data bus or by dedicated connections: clock 310, RAM 315, ROM 320, I/O communications port 325, a plurality of databases 330 and software 350. The CPU 305 of a partner server 300 may also be in communication with one or more input devices 335 (e.g., a keypad and a scanner) to enable the partner server 300 to receive information and instructions for storage therein.

As shown in FIG. 4A, one type of user interface device 110-1 may be a personal computer having one or more CPUs 111-1, one or more data storage devices 112-1 (e.g., a computer readable memory medium such as a hard disk, CD-ROM, DVD-ROM, and/or floppy diskette), a display device 113-1 (e.g., a monitor, screen or like device), a printer 114-1, one or more input devices 115-1 (e.g., a keyboard, pointing/selecting device such as a mouse or track ball, and/or touch screen interface), an I/O communications port 116-1, software 150-1 and other hardware components (not shown) to allow a user 105 to implement the commands of the software and hardware functions described herein.

Although one embodiment of the present invention may utilize a personal computer 110-1 as one type of user interface device 110, it is to be understood that a user interface device 110 may also be something other than a personal computer. For example, wireless devices such as cellular phones, personal digital assistants, two-way pagers and the like may be other types of user interface devices 110-2. As shown in FIG. 4B, such an alternative type of user interface device 110-2 may include a second type of display device 113-2 (e.g., a liquid crystal screen), second types of input devices 115-2 (e.g., buttons, keys, and/or a touch-sensitive pad), a second type of communications port 116-2 that may include a wireless communications device (e.g., a modem and/or cellular signal transmitter/receiver) and software 150.

The term “seat chartering coordinator” 116 and the like may include a person, entity, group, device, service or the like that can arrange for the charter of an individual seat on a ground transportation vehicle for carriage associated with an event. The term “ground transportation operator” 120 and the like may include a person, entity, group, device, service or the like that can provide a ground transportation vehicle (e.g., bus or motor coach operators, van operators and limousine operators). The term “marketing partner” 130 and the like may include a person, entity, group, device, service or the like that can provide, produce, sponsor, organize, promote, host, or otherwise facilitate in a broad sense an event. The term “marketing partner” 130 and the like may also refer to a search engine function or service. An illustrative but non-exhaustive list of types of marketing partners includes professional sports teams 130-1, collegiate athletics teams 130-2, university clubs 130-3, record labels 130-4, venue promoters 130-5 and the like. Terms defined herein are not limited to the examples listed.

As shown in FIG. 1, a marketing partner 130 may communicate with a user 105 by providing access to a partner server 300. For example, a marketing partner 130 (e.g., an event sponsor) may have a site residing on a partner server 300 to provide, among other things, information about an upcoming event. Such an event may include, by way of non-limiting example, a professional or collegiate sporting event, and a musical or theatrical production.

FIG. 1 also depicts communications the seat chartering coordinator 116 may have with users 105, ground transportation operators 120 and marketing partners 130. A seat chartering coordinator 116 communicates with one or more marketing partners 130 (either using devices shown in FIG. 1, or in another known way such as via mail, electronic mail, telephone or facsimile transmission) to obtain event information, such as date, time, location and other program specifics. The seat chartering coordinator 116 may then provide the seat chartering device 100 with one or more databases 230 that reflect this event information, and other information necessary to perform the functions and execute the transactions of the seat chartering device 100. In one embodiment, such one or more databases 230 may be accessed by a user 105 via a browser 152 running on a user interface device 110. Such an arrangement enables the seat chartering device 100 to provide a user 105 with information prior to the user's 105 selection of id ground transportation associated with (i.e., to an event, from an event, or both) a marketing partner's 130 event.

The user interface devices 110 may gain access to the network 140 in a known way, for example, by utilizing Internet service providers. When a user 105 requests access to a site on either the seat chartering device 100 or a partner server 300 (for example, by transmitting a registered domain name (e.g., “TheBusBank.com”) of the site, or by an alternative practice such as selecting a field, button or link located on another site), the user's 105 request is routed through the network 140 in a known way to the respective server (e.g. either one embodiment of the seat chartering device 100, or a partner server 300).

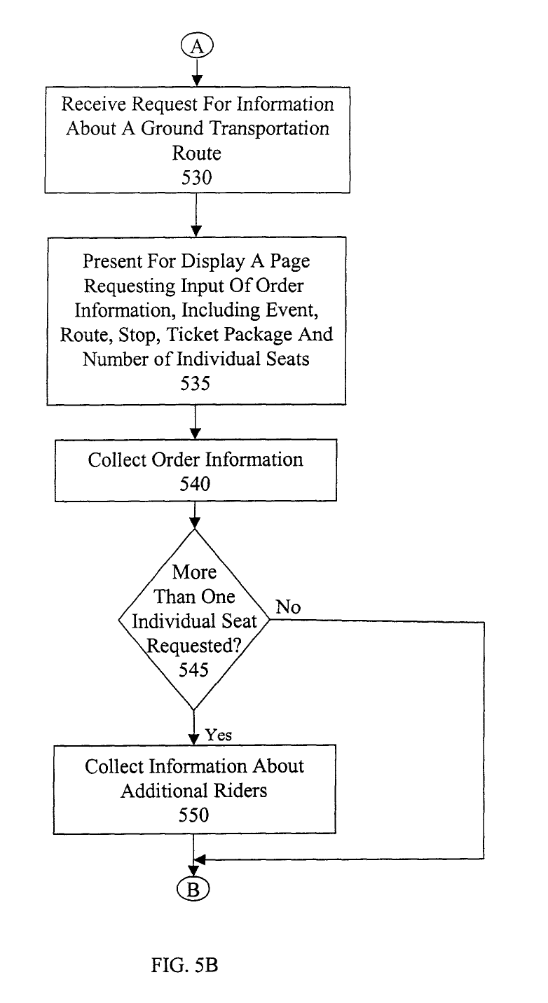

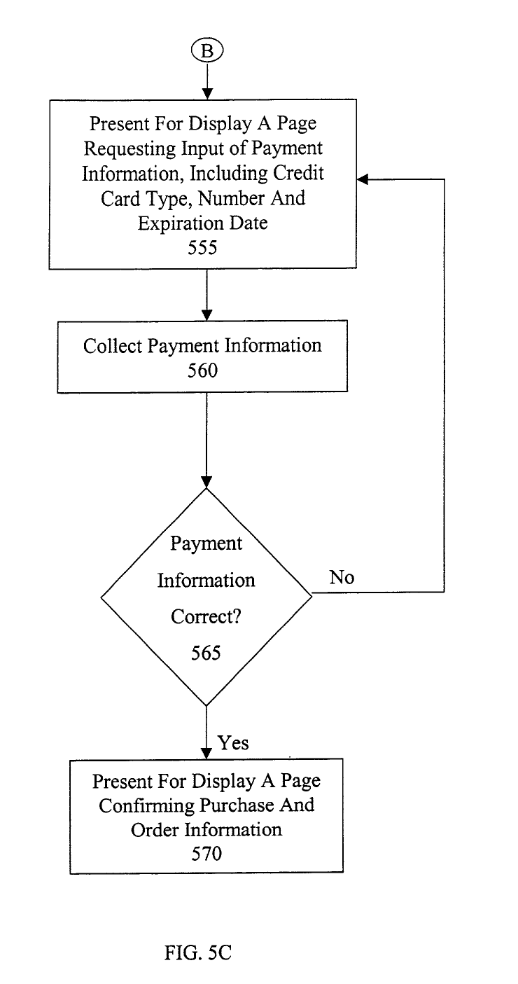

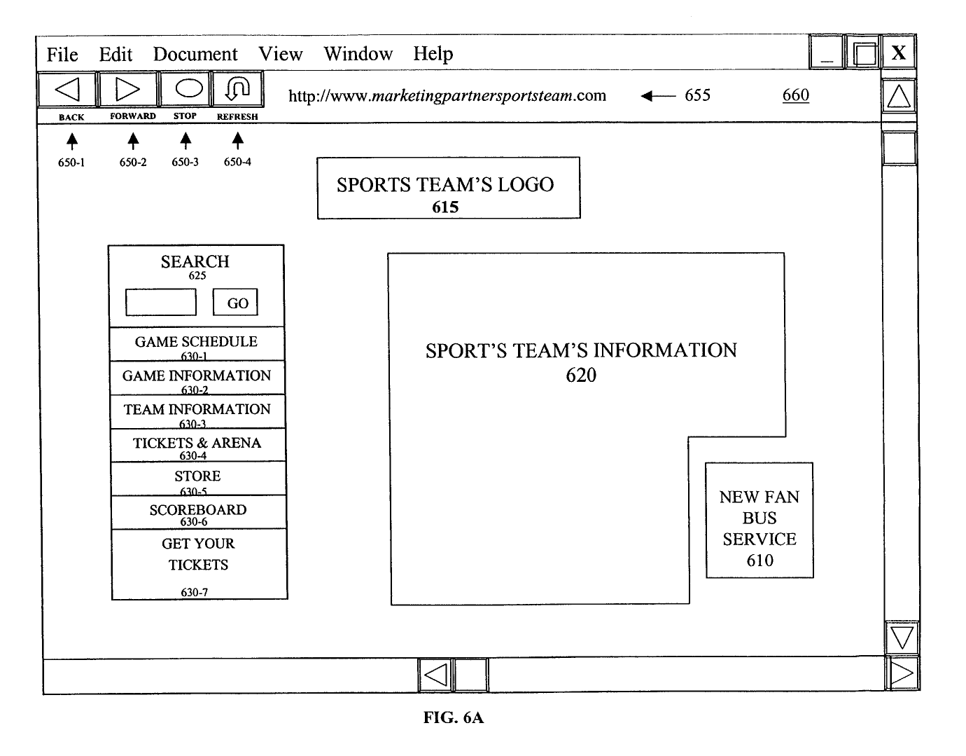

Having described the structure and functional implementation of certain aspects of embodiments of the seat chartering device 100, the operation and use of embodiments of the seat chartering device 100 will now be described with reference to FIGS. 5A-14C, and continuing reference to FIGS. 1-4B.

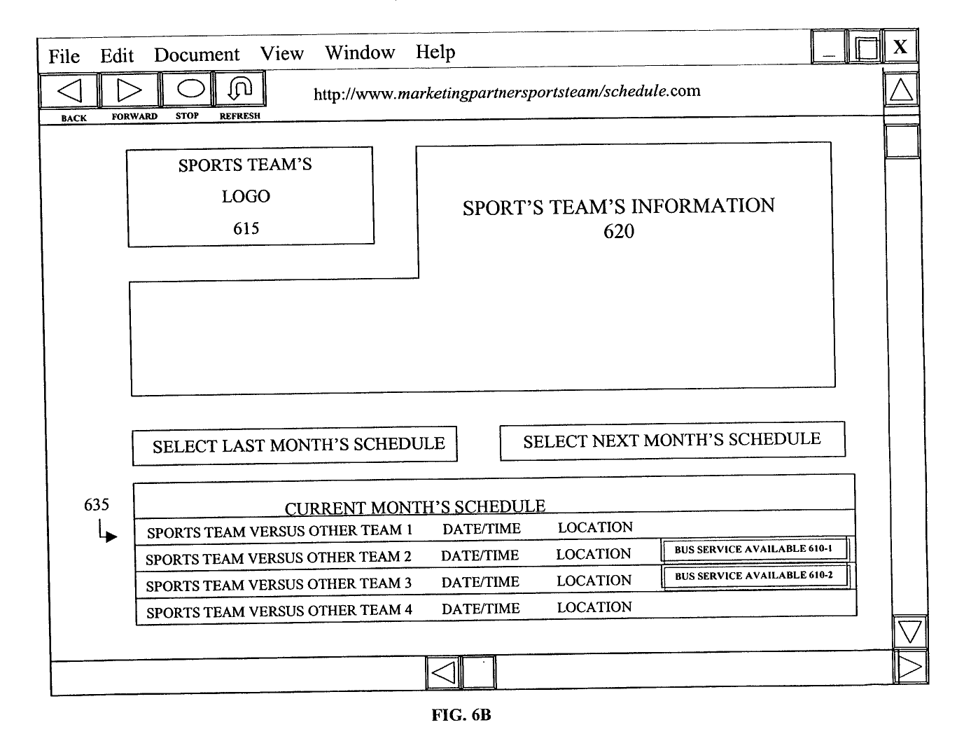

FIGS. 5A-5C illustrate certain operations of one embodiment of the seat chartering device 100. Using the network 140 and other devices in communication therewith, as described above, the seat chartering device 100 of one embodiment receives an indication that a ground transportation services identifier 610 has been selected (step 510). One example of a ground transportation services identifier 610 is an icon displayed on a home content page of a marketing partner 130 as shown in FIG. 6A. Another example of a ground transportation services identifier 610 is a link displayed on a schedule content page of a marketing partner 130 as shown in FIG. 6B. The ground transportation services identifier 610 may be, for example, an icon, word, phrase, character, number, picture, logo, moniker, link, field, sound, tone or other like indicator presented by or displayed on a user interface device 110 which indicates in some way to a user 105 that an option to obtain ground transportation arrangements to or from an event of interest exists or can be obtained.

The user 105 may select the ground transportation services identifier 610 by using an input device 115 to locate and activate (e.g., by “clicking” a mouse button) the identifier 610. In accordance with one embodiment, such an identifier 610 (e.g., an icon or active display field) is linked to another content page such that selection of the identifier 610 will cause to be displayed a content page of a seat chartering device 100. Use of hypertext links is one way to allow a user 105 to jump from the content page of a marketing partner 130 to a content page presented by an embodiment of the seat chartering device 100.

A content page displayed by a marketing partner 130 may also contain one or more hypertext links to further content pages containing further information about the marketing partner 130. In general, the user 105 may select a particular content page by selecting a link, using the browser control buttons 650-1, 650-2, 650-3, 650-4, or entering a URL address 655 in the address line 660. In connection with one embodiment, HTML enables a user 105 to view content pages and jump between them using hypertext links.

FIGS. 6A and 6B each show a portion of a sports team's content page containing one or more ground transportation services identifiers 610. However, the content page shown in FIG. 6A also includes the sports team's logo 615, information about the sports team 620, a field to input and request a search 625, and a variety of fields linking additional content pages 630. The content page shown in FIG. 6B is of the type that may be displayed upon a user's 105 selection of the “GAME SCHEDULE” field 630-1 shown in FIG. 6A. As shown, such a content page displays a schedule 635 of events, which includes ground transportation services identifiers 610-1, 610-2.

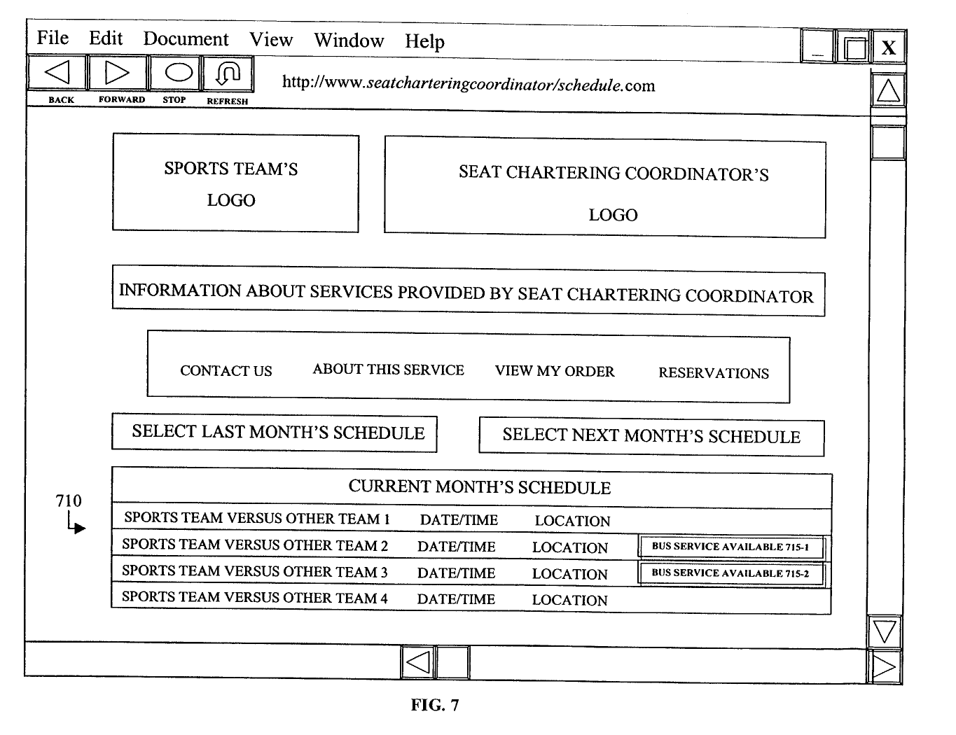

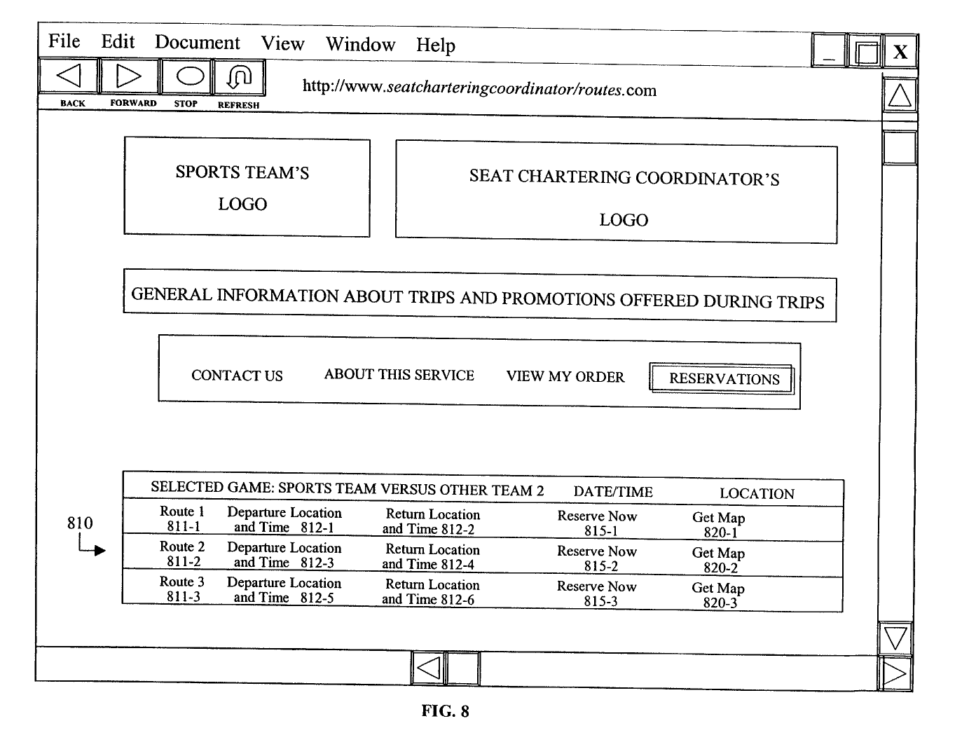

Selection of the ground transportation services identifier 610 shown in FIG. 6A causes one embodiment of the seat chartering device 100 to launch in its own browser instance and display the content page shown in FIG. 7. Selection of an identifier 610-1, 610-2 shown in FIG. 6B causes an embodiment of the seat chartering device 100 to launch in its own browser instance and display the content page shown in FIG. 8. However, the identifier 610 may also be a link to another content page not requiring a separate browser to be launched. Launching an embodiment of the seat chartering device 100 in its own browser instance may prevent security issues and site traffic competition.

In another step of an exemplary operation, the seat chartering device 100 of one embodiment presents for viewing by a user 105, via a display device 113, a content page as shown in FIG. 7. Such a content page includes a hypertext-linked display 710 showing the dates the marketing partner 130 has events along with corresponding event transportation identifiers 715-1, 715-2 (step 515). The content page shown in FIG. 7 is the first page presented by one embodiment of the seat chartering device 100 when a user 105 has selected a ground transportation services identifier 610 on a non-event specific content page of a marketing partner 130 (e.g., FIG. 6). An event transportation identifier 715 may be, for example, an icon, word, phrase, character, number, picture, logo, moniker, link, field, sound, tone or other like indicator. When the user 105, operating a user interface device 110, selects one or more event transportation identifiers 715, the seat chartering device 100 of one embodiment receives a request for information about ground transportation services associated with an event (step 520).

In yet another step of an exemplary operation, the seat chartering device 100 of one embodiment presents for viewing by a user 105, a listing 810 of routes 811 (shown in FIG. 8) and stops 812 to be provided for ground transportation carriage associated with an event (step 525). The content page shown in FIG. 8 is the first page presented by one embodiment of the seat chartering device 100 when a user 105 has selected a ground transportation services identifier 610-1, 610-2 on an event specific content page of a marketing partner 130 (e.g., FIG. 6B). The user 105, operating a user interface device 110, then selects one or more routes 811 by, for example, selecting a “RESERVE NOW” field 815-1, 815-2, 815-3, thereby sending the seat chartering device 100 a request for information about the particular route 811 and stop or stops 812 selected (step 530). A user's 105 selection of a “GET MAP” field 820-1, 820-2, 820-3 will cause a content page containing a map of the particular route 811 and/or stop 812 to be displayed.

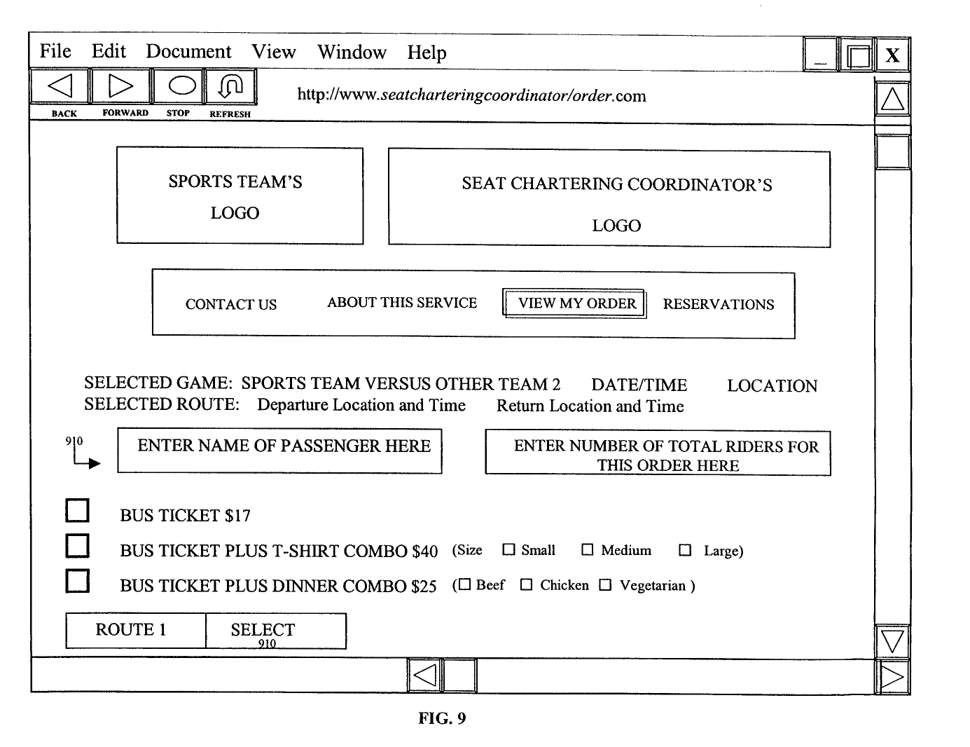

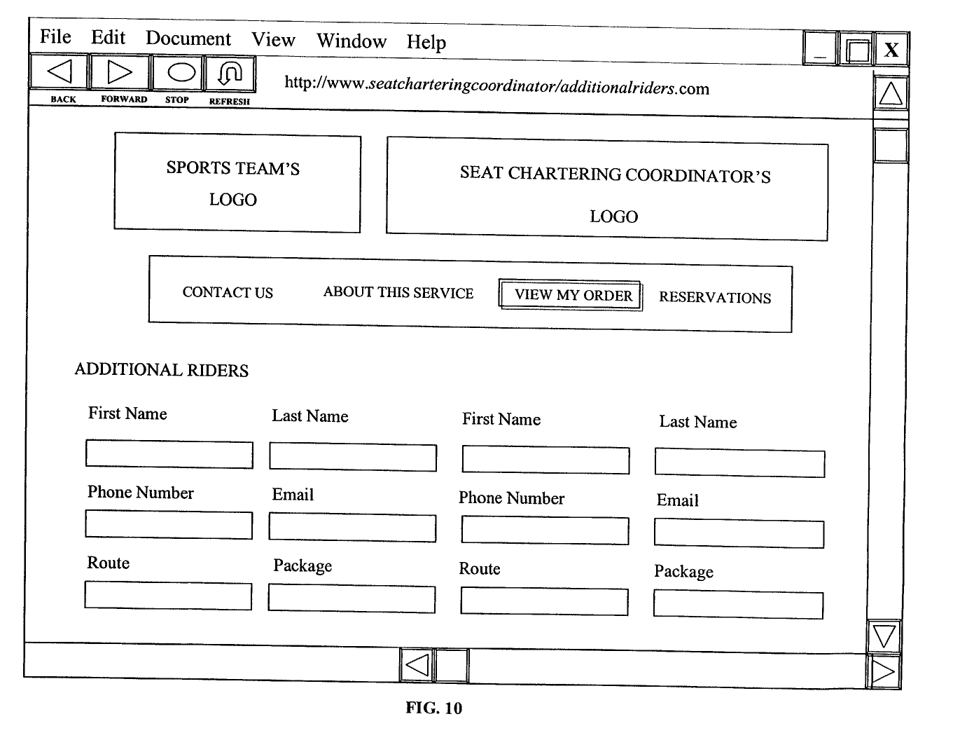

In a further step of an exemplary operation, the seat chartering device 100 of one embodiment presents a user 105 with a content page requesting order information 910 (shown in FIG. 9) for at least one individual seat on a ground transportation vehicle for carriage to and/or from the event (step 535). In one embodiment, the order information 910 includes identification of the event, the route, a departure and/or return stop along the route, a ticket package, and the number of individual seats. In such an embodiment, the user 105 can also specify additional products and/or services to be included in the ticket package, such as admission to the event or other promotional materials such as, e.g., t-shirts, hats, and/or food items. The user 105, operating a user interface device 110, then inputs the order information and sends it to the seat chartering device 100 of one embodiment (step 540) by, for example, selecting the “SELECT” field 910 shown in FIG. 9. If the user 105 indicates that more than one seat is desired, the seat chartering device 100 of one embodiment may prompt the user 105 to enter information about the additional riders (shown in FIG. 10) (steps 545 and 550).

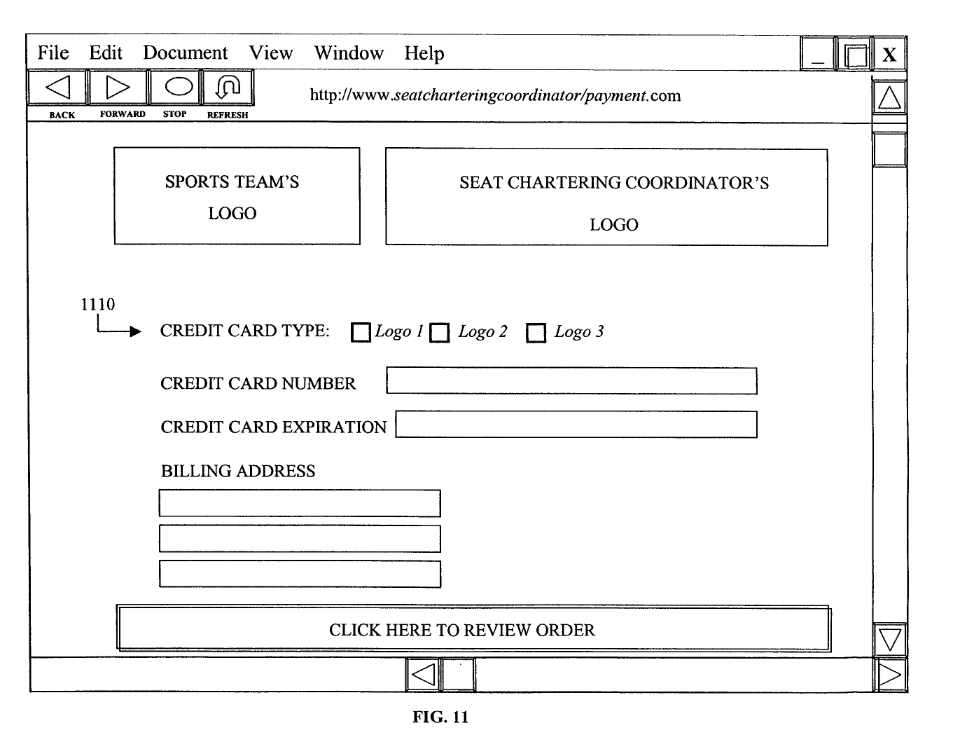

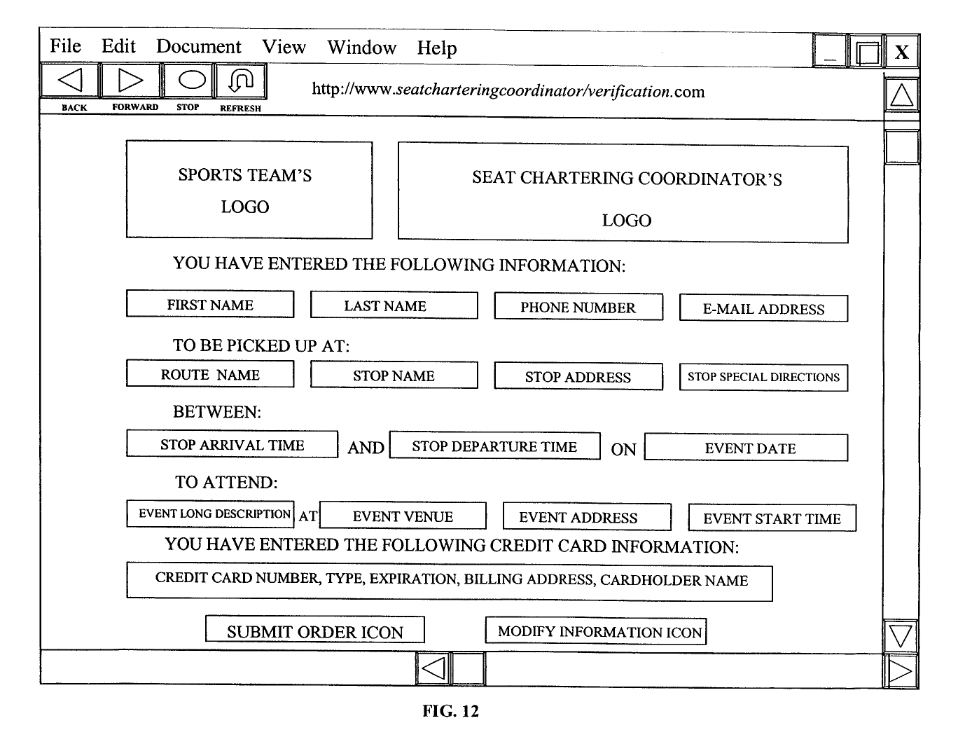

In yet another step of an exemplary operation, the seat chartering device 100 of one embodiment presents a user 105 with a content page requesting input of payment information 1110 (shown in FIG. 11) (step 555). Payment information 1110 may include credit card type, credit card number, credit card expiration date, and cardholder billing address. In one embodiment, the seat chartering device 100 collects from the user 105 the payment information 1110 (step 560) and asks the user 105 to confirm the accuracy of the information (step 565). The seat chartering device 100 may also provide the user 105 with a printable order confirmation page (shown in FIG. 12), which may contain a summary of the order and payment information. If the seat chartering device 100 receives an indication from the user 105 that the purchase transaction is to be initiated (step 565), then the credit card may be transacted electronically.

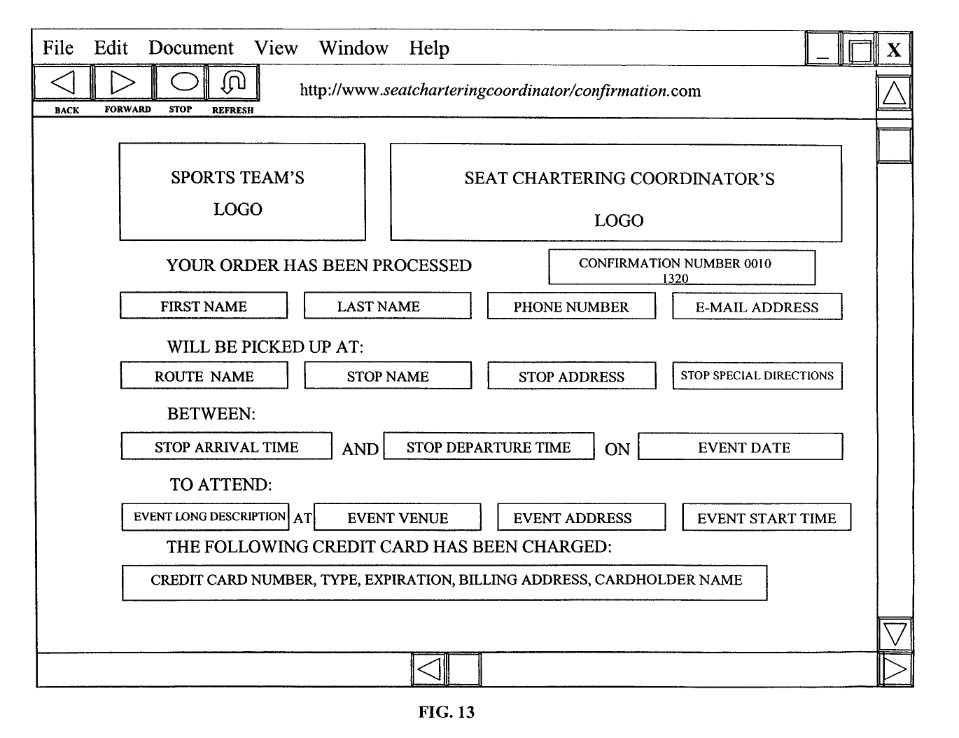

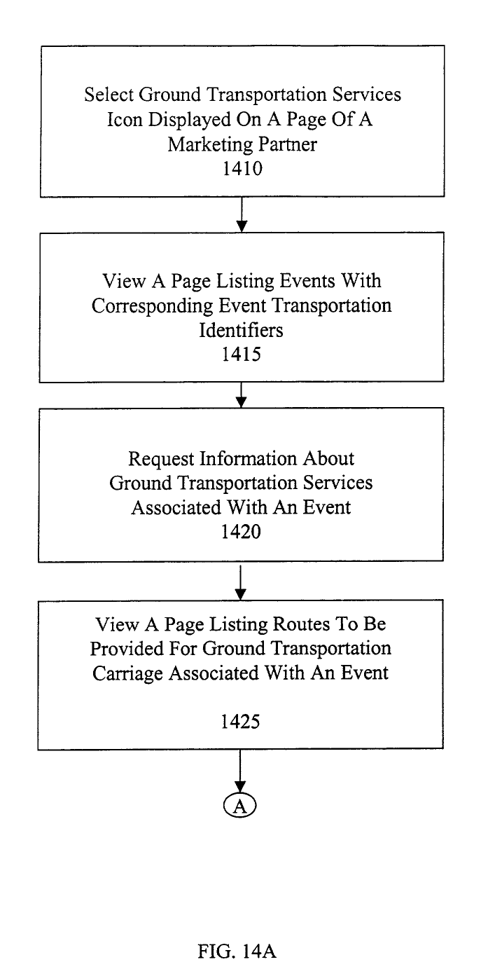

Once the user 105 has verified that the order information and the payment information is correct, and the user's 105 credit card has been charged, the seat chartering device 110 of one embodiment presents for viewing to the user 105 a purchase confirmation page (shown in FIG. 13) (step 570). The purchase confirmation page may have a confirmation number 1320 to inform the user 105 that the purchase was completed and the order was processed (step 570).

According to one embodiment, the purchase confirmation page provides a link to allow certain aspects (i.e., non-financial) of the trip itinerary to be transmitted via electronic mail to others. For example, if a user 105 selects a specific stop, the details for that stop may be accessible. According to another embodiment, a user 105 who wishes to be reminded when an event nears can opt in at the time of purchase to receive an automatic reminder. Similarly, one embodiment of the seat chartering device 100 allows users 105 who wish to be told of other ground transportation opportunities may opt in to receive marketing materials via electronic mail. According to another embodiment, a static explanation page may explain the details of the reservation and purchase process to the user 105 upon request.

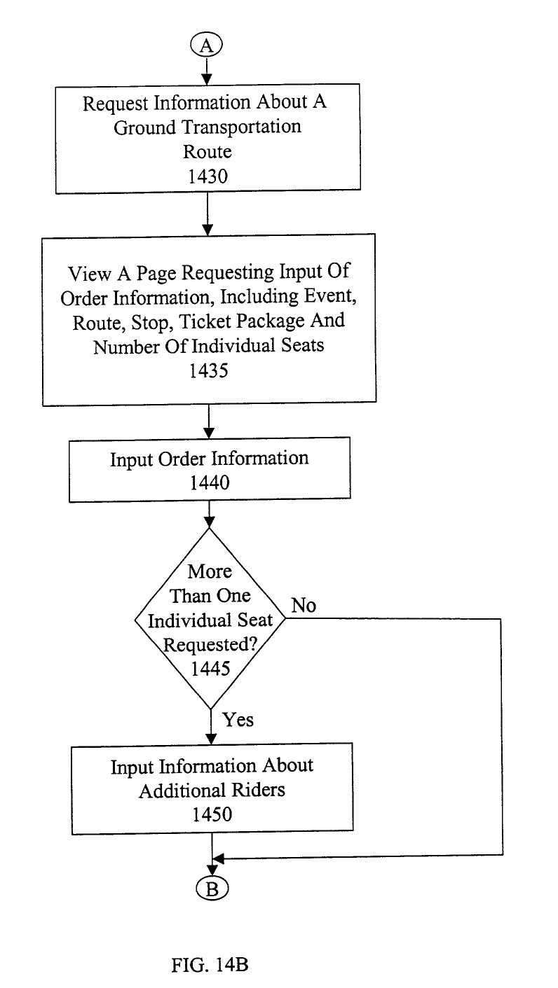

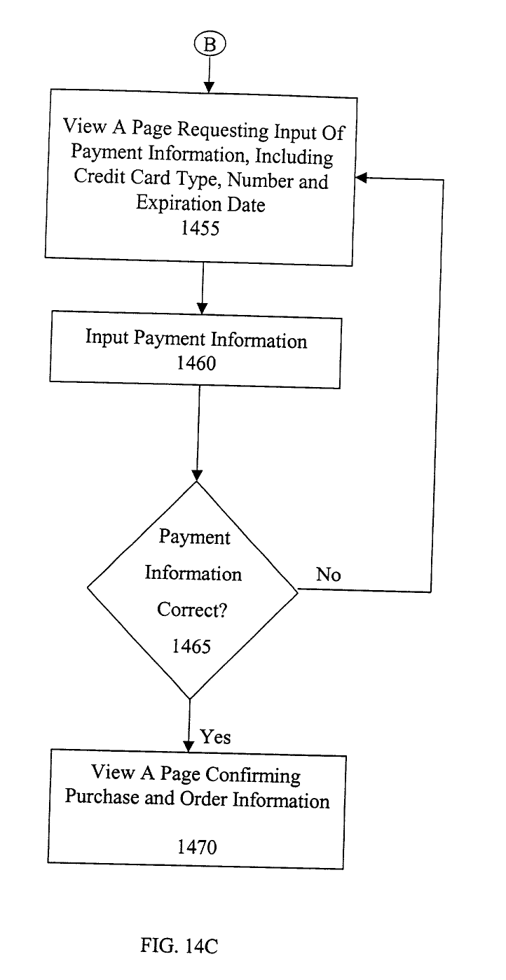

FIGS. 14A-14C show steps of one operation from the perspective of a user 105 interacting with an embodiment of the seat chartering device 100. As shown and described above, a seat chartering device 100 prompts a user 105 through content pages to charter an individual seat for carriage on a ground transportation vehicle between a stop and a particular event.

Although specific embodiments of the present invention have been shown and described, it is to be understood that there are other embodiments which are equivalent to those described. For example, the scope of the present invention is not limited to execution of the aforementioned steps in the order discussed. Accordingly, the invention is not to be limited by the specific illustrated embodiments, but only by the scope of the appended claims.

What is claimed is:

1. A method comprising:
receiving, over a network, an indication that an identifier presented by another has been selected;
providing data indicative of an arrangement for ground transportation associated with an event; and
receiving data descriptive of an order for a seat on a ground transportation vehicle for carriage between a stop and said event.

2. The method of claim 1, further comprising providing confirmation of receipt of said order.

3. The method of claim 2, further comprising receiving data descriptive of a request for purchase of said seat on a ground transportation vehicle.

4. The method of claim 3, further comprising confirming purchase of said seat on a ground transportation vehicle.

5. The method of claim 1, wherein said order specifies a particular seat located on a ground transportation vehicle.

6. The method of claim 1, wherein said data indicative of an arrangement for ground transportation is provided at a time of or prior to obtaining a ticket for admission to said event.

7. The method of claim 1, wherein said order specifies a route.

8. The method of claim 1, wherein said identifier identifies a seat chartering coordinator.

9. The method of claim 1, wherein said data indicative of an arrangement for ground transportation associated with an event comprises a field displayed on a content page.

10. The method of claim 1, wherein said order contains a request for admission to said event.

11. The method of claim 1, wherein said identifier comprises an icon displayed on a user interface device.

12. The method of claim 1, wherein said providing data indicative of said arrangement for ground transportation occurs substantially simultaneously after said receiving said indication that said identifier has been selected.

13. A method comprising:
receiving, over an internet network, an indication that an icon displayed by another has been selected;
presenting for display a first content page providing data descriptive of an event with a corresponding identifier indicative of an arrangement for ground transportation associated with said event;
receiving a request for information about ground transportation services associated with said event;
presenting for display a second content page providing data descriptive of a route for ground transportation associated with said event;
receiving a request for information about said route;
presenting for display a third content page requesting an order for a seat on a ground transportation vehicle for carriage between a stop and said event;
receiving said order;
presenting for display a fourth content page requesting payment information;
receiving said payment information; and
presenting for display a fifth content page providing data descriptive of a confirmation of said order and payment therefore.

14. A method comprising:
receiving an indication that an identifier presented by another has been selected;
providing data indicative of an arrangement for ground transportation associated with an event; and
receiving data descriptive of an order for a seat on a ground transportation vehicle for carriage between a stop and said event.

15. A method comprising:
causing to be sent an indication that an identifier presented by another has been selected;
receiving data indicative of an arrangement for ground transportation associated with an event; and
providing data descriptive of an order for a seat on a ground transportation vehicle for carriage between a stop and said event.

16. The method of claim 15, further comprising receiving confirmation of receipt of said order.

17. The method of claim 16, further comprising providing data descriptive of a request for purchase of said seat on a ground transportation vehicle.

18. The method of claim 15, wherein said order specifies a particular seat located on a ground transportation vehicle.

19. The method of claim 15, wherein said identifier comprises an icon displayed on a user interface device.

20. The method of claim 15, further comprising providing said data indicative of an arrangement for ground transportation at a time of or prior to obtaining a ticket for admission to said event.

21. The method of claim 15, wherein said order specifies a route.

22. The method of claim 15, wherein said order contains a request for admission to said event.

23. A method comprising:
receiving an indication that an identifier presented by another has been selected;
providing data indicative of an arrangement for ground transportation associated with an event; and
receiving data descriptive of a request for a seat on a ground transportation vehicle for carriage between a stop and said event.

24. A method comprising:
receiving, over an internet network, a request for purchase of a seat on a ground transportation vehicle for carriage between a stop and an event; and
providing, over said internet network, confirmation of said request for purchase of said seat on a ground transportation vehicle.

25. A method comprising:
requesting, over an internet network, purchase of a seat on a ground transportation vehicle for carriage between a stop and an event; and
receiving, over said internet network, confirmation of said request for purchase of said seat on a ground transportation vehicle.

26. A device comprising:
means for receiving an indication that an identifier presented by another has been selected;
means for providing data indicative of an arrangement for ground transportation associated with an event; and
means for receiving data descriptive of an order for a seat on a ground transportation vehicle for carriage between a stop and said event.

27. A device comprising:
means for receiving, over an internet network, an indication that an icon displayed by another has been selected;
means for presenting for display a first content page providing data descriptive of an event with a corresponding identifier indicative of an arrangement for ground transportation associated with said event;
means for receiving a request for information about ground transportation services associated with said event;
means for presenting for display a second content page providing data descriptive of a route for ground transportation associated with said event;
means for receiving a request for information about said route;
means for presenting for display a third content page requesting an order for a seat on a ground transportation vehicle for carriage between a stop and said event;
means for receiving said order;
means for presenting for display a fourth content page requesting payment information;
means for receiving said payment information; and
means for presenting for display a fifth content page providing data descriptive of a confirmation of said order and payment therefore.

28. A device comprising:
a memory having embodied therein data descriptive of an arrangement for ground transportation associated with an event; and
a processor in communication with said memory, said processor configured:
to receive, over a network, an indication that an identifier presented by another has been selected;
to provide data indicative of an arrangement for ground transportation associated with an event; and
to receive data descriptive of an order for a seat on a ground transportation vehicle for carriage between a stop and said event.

29. The system of claim 28, wherein said processor is further configured to provide confirmation of receipt of said order.

30. The system of claim 29, wherein said processor is further configured to receive data descriptive of a request for purchase of said seat on a ground transportation vehicle.

31. The system of claim 30, wherein said processor is further configured to confirm purchase of said seat on a ground transportation vehicle.

32. A computer-readable storage medium encoded with processing instructions for implementing a method, said processing instructions for directing a computer to perform the steps of:
receiving an indication that an identifier presented by another has been selected;
providing data indicative of an arrangement for ground transportation associated with an event; and
receiving data descriptive of an order for a seat on a ground transportation vehicle for carriage between a stop and said event.
